(19) United States
(12) Patent Application Publication
(10) Pub. No.: US 2008/0131007 A1
(43) Pub. Date: Jun. 5, 2008

(54) Image Coding Method and Image Coding Device

(76) Inventor: Robert Kutka, Geltendorf (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/794,148

(22) PCT Filed: Dec. 22, 2005
(86) PCT No.: PCT/EP05/57096

§ 371 Date: Jun. 25, 2007

(30) Foreign Application Priority Data
Dec. 23, 2004 (DE) 102004062382.1

(51) Int. Cl. G06K 9/36

(52) U.S. Cl. 382/232

(57) ABSTRACT

Presented is a method of image coding with at least one non-flash exposure and at least one flash exposure of the same subject. The method includes-creating from at least one non-flash exposure a non-flash image, creating from at least one flash exposure a flash image, and generating a resulting representation from a combination of the flash image and the non-flash image. The at least one of the images undergoes at least one brightness or color adjustment for increasing a contrast range of the respective image.

The invention relates to an image coding method as claimed in the preamble of claim 1 and an image coding device as claimed in the preamble of claim 8.

Devices for taking photographs have been a mass-market product for many years. In the wake of digital imaging the mass market for photography has now experienced a new surge of enthusiasm. Thus a plurality of digital cameras has been offered on the market in recent years. In addition mobile radio devices have also provided the option of taking photographs for some time now. The introduction of the Multimedia Messaging Service (MMS) has also enabled users to transfer photographs easily and quickly.

Many of the devices which allow photographs to be taken obtain brilliant image quality in daylight or with good lighting of the objects to be photographed. It has been shown however that in dark lighting conditions these devices sometimes deliver photos or images of unacceptable quality. It is known for example in connection with this problem that digital image sensors amplify electrical image signals to brighten recorded images, but in doing so can however simultaneously create troublesome image noise.

A normal method of taking photographs in dim lighting is to use a flash unit. In a photography studio the object of which an image is to be recorded, such as a person for example, is lit in the optimum way with the aid of a plurality of lighting sources. By contrast, portable devices generally only provide one flash unit. Such a flash unit achieves an average image quality for image objects which are at a specific distance from the flash unit. By contrast image objects which are located too close to the flash unit can be recorded too bright and image objects which are too far away merely appear dark. The terms image, photo and photography are used synonymously in this document.

The object of the present invention is thus to specify an image coding method or an image coding device which also obtains good image quality when a flash is used to take photographs.

Using the image coding method in accordance with the preamble of claim 1 as its starting point, this object is achieved by the claim's characterizing features. This object is further achieved by the image coding device as claimed in claim 8 by the claim's characterizing features.

In the image coding method with at least one image of the same subject taken using flash and one taken without using flash, a non-flash image is created from at least one non-flash exposure and a flash image is created from at least one flash exposure, with at least one of the images being subjected to at least one brightness or color adjustment to increase the contrast range in each case, and a resulting representation being generated from a combination of the images taken with flash and without flash.

The inventive method makes it possible to generate from at least one image recorded with flash and one recorded without flash a resulting representation which has a better image quality than one of the images recorded without flash. In a first step the respective contrast range is increased, by adjusting the brightness or color, in such a way that differences in brightness or color which are small in the exposures show up more clearly in the resulting presentation. The result achieved by combining the images taken with and without flash is that, in the images taken with flash, points which are too bright, such as an object in the foreground of the image which is too bright for example, become darker and dark points in the image, such as an image background for example, are brightened. Furthermore the combination reduces troublesome image noise.

Preferably the brightness or color adjustment of a brightness or color distribution of at least one exposure is performed with the aid of linear spreading. The linear spreading achieves an increase in the contrast range with a low complexity of processing.

If the brightness or color adjustment of a brightness or color distribution of at least one exposure is performed with the aid of spreading in such a way that the spreading increases with an increase in the probability of occurrence of a brightness value or color value of the image, the increase in the contrast range can be adjusted adaptively to the probability of occurrence of the brightness value or color value and thus the image quality can be increased compared to the linear spreading method.

Furthermore the color adjustment of a color distribution of at last one exposure can be undertaken in such a way that a color value of a pixel is spread with that spread factor which is used for the brightness adjustment of this pixel. In this way the color adjustment of at least of one pixel is determined as a function of the brightness adjustment of the same pixel. Within the exposure of images, such as exposing images using flash for example, different variants of the brightness or color adjustment can be applied.

Preferably the non-flash image is determined by overlaying a number of non-flash exposures and/or flash image is determined by overlaying a number of flash exposures. As a result of overlaying a number of exposures image noise can be reduced and an increased image quality obtained from this.

If a movement compensation of the non-flash and the flash exposures is performed before the overlaying in each case, artifacts within the non-flash or flash images can be reduced and the image quality additionally increased thereby.

In addition the flash and/or non-flash image can be qualitatively processed by at least one image processing method, especially by noise reduction. The noise reduction can be undertaken using a lowpass filter. A further increase in the image quality can be obtained in this way.

Preferably the combination of the flash image and the non-flash image is implemented using weighted addition. This guarantees a simple and efficient implementation of the combination of the flash image and the non-flash image.

The invention further relates to the image coding device for executing an image coding method with at least one non-flash exposure and at least one flash exposure of the same subject, with a first means for creating a non-flash image form at least one non-flash exposure and a second means for creating a flash image from at least one flash exposure, with said means being embodied such that at least one of the images is subjected to at least one brightness or color adjustment to increase the respective contrast range, and a third means for generating a resulting representation from a combination of the flash and the non-flash image. The image coding device enables the inventive image coding method to be executed.

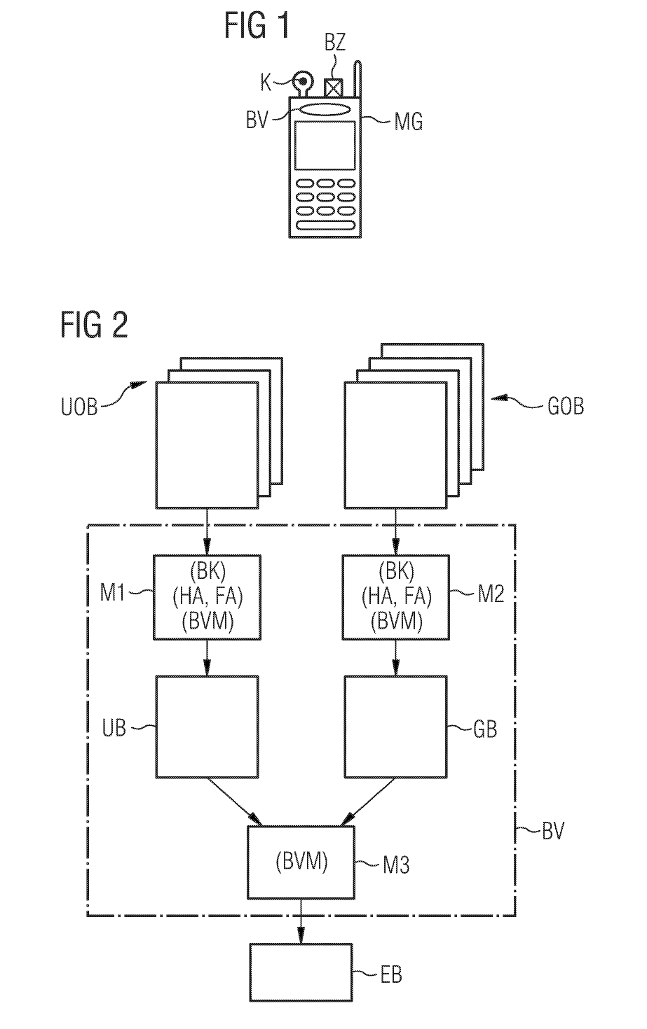

Further details of the invention and their advantages are explained in greater detail with reference to FIGS. 1 to 8. The figures show:

FIG. 1 a mobile radio device which includes an image coding device for executing the inventive image coding method;

FIG. 2 a flowchart for executing the inventive image coding method;

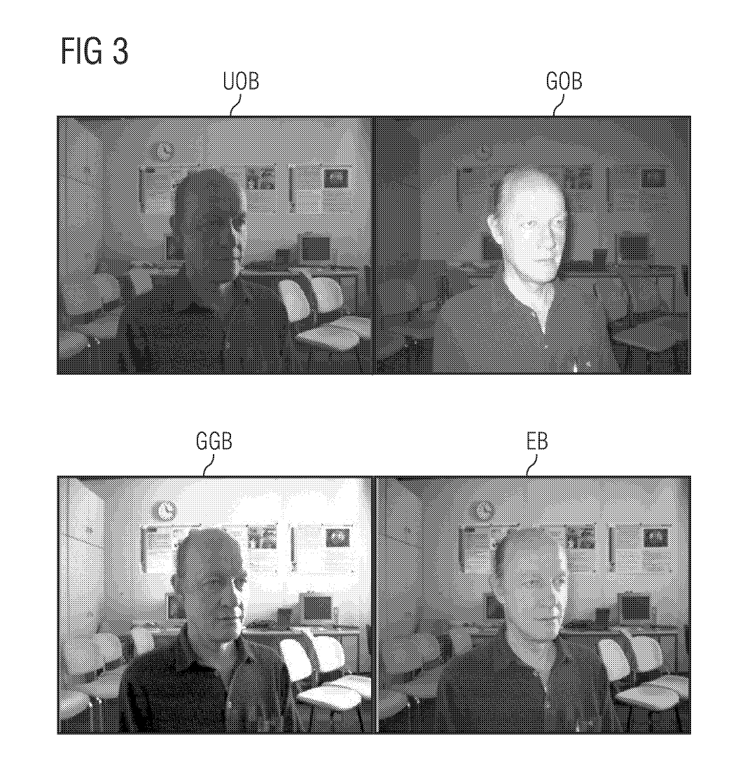

FIG. 3 depictions of a number of images using the inventive image coding method.

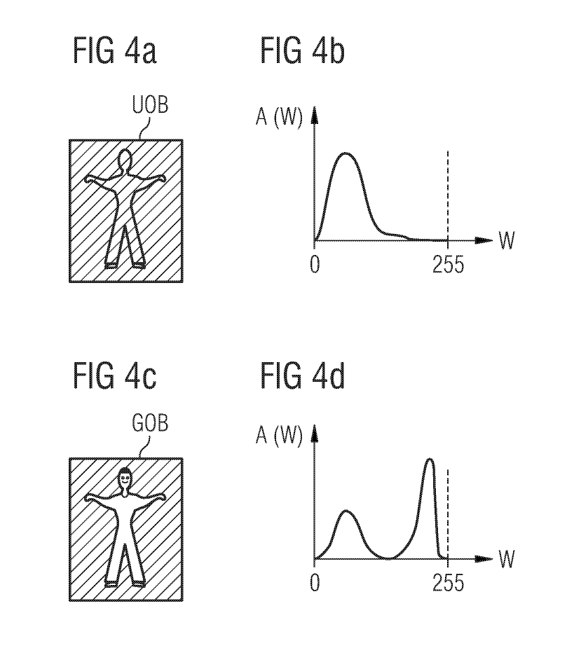

FIG. 4 with figure parts a to d, a brightness distribution in a non-flash and a flash image;

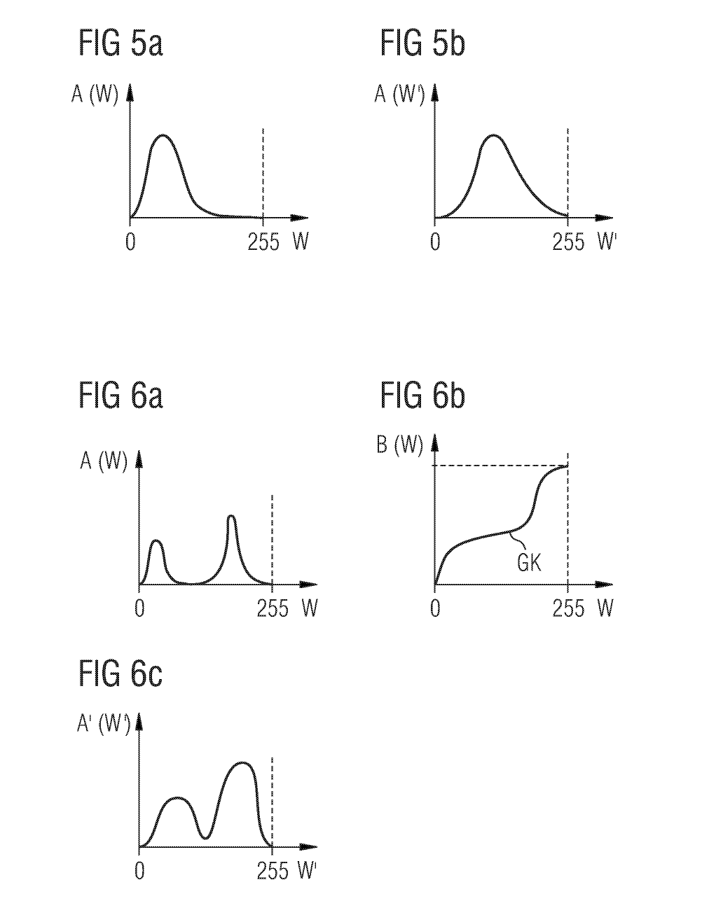

FIG. 5 in figure parts a and b, a linear spreading of the brightness values in a brightness histogram;

FIG. 6 with figure parts a to c, a spreading of brightness values in a brightness histogram, where the respective spreading increases with the increase in the probability of occurrence of the respective brightness value;

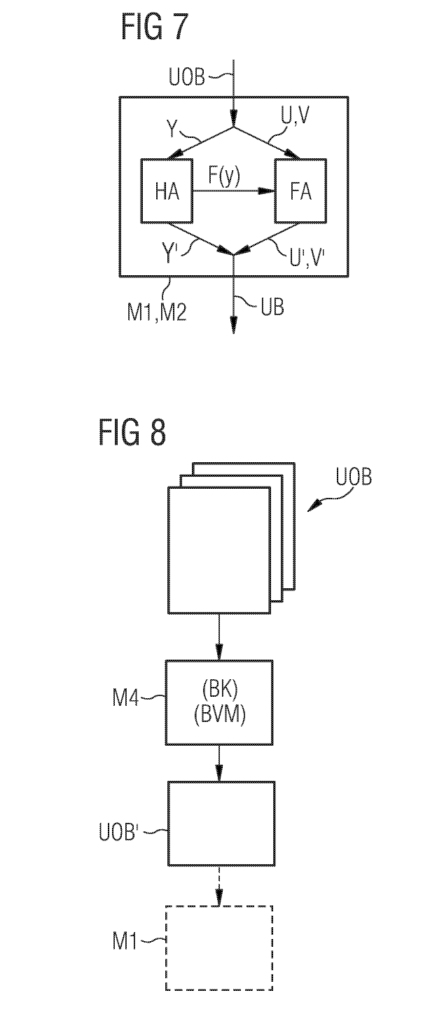

FIG. 7 a generation of the non-flash image from a non-flash exposure, with the color value of a pixel being modified as a function of the respective spread factor of the associated brightness value of this pixel determined by the brightness adjustment;

FIG. 8 a flowchart for part execution of the inventive image coding method, with a corrected non-flash image being determined from a number of non-flash exposures using movement compensation;

Elements with the same function and method of operation are provided with the same reference symbols.

To execute the inventive image coding method a mobile radio device MG can be used, which has a camera K, a flash unit BZ and an image coding device BV, with the image coding device BV implementing the inventive image coding method. This type of mobile radio device MG can be seen in FIG. 1. This mobile radio device MG supports the GSM (Global System for Mobile Communication) Standard for example. Instead of a mobile radio device MG the inventive image coding method can also be implemented and realized in a digital camera or photography device, which processes similar images. The individual processing steps of the inventive method are shown in FIG. 2 and will be explained in greater detail below.

To execute the inventive method the mobile radio device MG initially generates a non-flash exposure UOB and a flash exposure GOB of the same subject. To achieve a very good result of the inventive image coding method it is useful in practice for both the non-flash and also the flash exposure UOB or GOB to show the same subject. In this case the term “the same subject” is to be understood as the image objects not changing their position or only changing their position slightly in these two exposures. Both brightness and also color differences of the different exposures can also occur with the same subject. To this end it is useful in practice for the non-flash and the flash exposure UOB or GOB example to be generated by the mobile radio device MG within a short interval, such as for example within 30 ms. The result of this very short exposure time of the two exposures is that the subject recorded is the same. Examples of a non-flash and flash exposure UOB, GOB are depicted in parts 3a and 3b of FIG. 3.

As well as the opportunity of only creating one non-flash or flash exposure UOB or GOB in each case, in an alternative expansion of the inventive method, a number of non-flash or flash exposures UOB, GOB can be generated. This will be dealt with later.

One exposure, such as a flash exposure GOB for example, includes a plurality of pixels BP. A pixel BP can be represented by one or more components, especially through the color components red/green/blue (R/G/B) or through a brightness component Y and two color components U, V. A pixel BP can thus be written as BP (R, G, B) or BP (Y, U, V).

The characteristic of the non-flash or flash UOB or GOB is explained in greater detail with reference to FIG. 4. Part 4a of FIG. 4 shows a non-flash exposure UOB, in which an image of a person has been recorded. The transverse lines in FIG. 4a are used to indicate that the entire non-flash exposure UOB features only dark areas of the picture. A further non-flash exposure UOB can be seen in FIG. 3a. An analysis of the distribution of the brightness values within the non-flash exposure UOB can be undertaken with the aid of a brightness histogram. FIG. 4b shows a brightness histogram of this type. The abscissa of this brightness histogram shows the brightness value W, with “0” corresponding to the color black, “255” to the color white and brightness values W between “0” and “255” corresponding to a gray value. The probability of occurrence A(W) or the frequency of a respective brightness value A(W) is plotted on the ordinate axis. This type of brightness histogram is known from [1] page 129 to 143. As can be seen in FIG. 4b, the non-flash exposure UOB of FIG. 4a mainly comprises picture areas and thus predominantly dark brightness values W.

FIG. 4c depicts the same person as in FIG. 4a, with this exposure having been made using a flash unit however. Thus FIG. 4c represents a flash exposure GOB, of which the distinguishing feature is that the face of the person recorded is bright, whereas the background is dark in relation to the person. This state of affairs is shown in the associated brightness histogram in FIG. 4d by the fact that a brightness maximum exists in each case both for dark and also for bright brightness values W of the brightness histogram. The brightness histograms shown in the parts 4b and 4d of FIG. 4 merely represent one possible exemplary embodiment and can occur for other flash or non-flash exposure in changed form.

With the aid of a first or second means M1, M2 at least one of the exposures UOB, GOB is subjected to at least one brightness or color adjustment HA, FA for increasing the respective range of contrast. In accordance with the present invention a flash and/or a non-flash exposure GOB, UOB can be adjusted. Furthermore this adjustment can be undertaken both for the brightness and for the color and also for the brightness and the color of an exposure.

In this exemplary embodiment an increase in the respective contrast range is explained in greater detail with reference to the brightness adjustment HA. The brightness histogram from FIG. 4b is depicted in FIG. 5a. This shows that the preponderant numbers of pixels of the non-flash exposure UOB are dark pixels and the non-flash exposure UOB does not feature any bright pixels.

In a variant of the inventive method the distribution of the brightness values W within the brightness histogram is spread linearly. The result of this linear spreading can be seen in FIG. 5b. In this case it can be seen that the brightness histogram has both black and also white modified brightness values W′ and the maximum of the probability of occurrence A(W′) of the modified brightness values W′ of dark brightness values has migrated in the direction of middle brightness values=gray values. This type of brightness correction is for example known from [1] page 178 to 179 with the spreading being referred to there as tone value spreading. The result achieved by the spreading is that the range of contrast of the brightness values increases.

A possible alternative variant for linear spreading is explained with the aid of the parts 6a to 6c of FIG. 6. FIG. 6a reproduces the brightness histogram of a flash exposure GOB in accordance with FIG. 4d. The striking feature here is that the flash exposure GOB features a plurality of dark and very bright pixels with pixels in the mid brightness range barely being present. For spreading the curve of the brightness values from FIG. 6a a gradation curve is first determined. Gradation curves are for example known from [1] page 140 to 143. The gradation curve GK in accordance with FIG. 6b is formed for example such that, over the range of values W, from 0 to 255 or from black to white, the probability of occurrence of the brightness value A(W) is summed and plotted on the ordinate. With the aid of this gradation curve GK the original range of values W is now spread and a new modified range of values W′ is produced. The modified range of values W′ typically includes a range of values from “0” to “255”.

In FIG. 6c it can be seen that the respective maxima of the brightness distribution have become broader. Thus brightness values with a high probability of occurrence are more greatly spread than brightness values with a low probability of occurrence. In general the spread is greater the higher the probability of occurrence of a brightness value is. With this type of spreading it is achieved that the range of contrast can be markedly increased since brightness values which occur frequently are more greatly spread than brightness values which occur more rarely. FIG. 3c in the spread image GGB the non-flash mapping UOB from FIG. 3a is printed after application of this type of spreading.

In general a modified brightness value W′ is formed from a spread factor F and the brightness value W. This can be described by the following equation:

W′=F(W)

With the aid of the first or second means M1, M2 the respective exposures UOB, GOB are subjected at least to brightness or color adjustment HA, FA. As a result of this processing step the first means M1 creates a non-flash image UB and the second means M2 a flash image GB. Both the non-flash and also the flash image UB, GB have a markedly improved range of contrast over the original non-flash or flash exposure UOB, GOB.

As an alternative or in addition, a color adjustment FA can also be performed by the first or second means M1, M2 in addition to the brightness adjustment HA. The color adjustment FA is performed in the same procedure as the brightness adjustment HA, with instead of the brightness component W=Y of the pixels BP, one or more color components, such as W=U or W=V, of the pixels BP being processed.

In an alternative embodiment the color adjustment FA can be performed as a function of the brightness adjustment HA.

This is shown graphically in FIG. 7. For example a pixel includes a brightness component Y and two color components U, V. Initially the brightness component Y is subjected with the aid procedure described above to a brightness adjustment HA. A modified brightness component Y′ is produced by this which can be described by the following equation:

Y′=F(Y)

In this case F describes that spread factor which was applied for spreading the brightness values Y into the associated modified brightness value Y′. The spread factor F can change as a function of the brightness value Y.

The color component U is subsequently subjected to a color adjustment FA as a function of the brightness adjustment HA:

U′=F(Y)*U.

Thus the spreading of the color components U is directly dependent on the spread factor F which was used for the brightness adjustment HA. The reference symbol U′ represents a modified color value after the spreading. If for example the color component U describes a differential color component with for example the value 127 in the range of values of 0 to 255 representing the color zero point, the modified color value U′ can be determined as follows:

U′=(F(Y)*(U−127))+127.

For determination of the color component V or of a modified color component V′ the procedure can be the same as for color component U or modified color component U′.

With said embodiment the brightness or color values are defined by decimal numbers within a predetermined range of values, such as from 0 to 255 for example. This range of values specifies the brightness or color resolution. In the present example 265 different brightness or color values can be reproduced. The inventive image coding method is not restricted to a specific range of values, such as 0 to 256 for example, but can be used for any given range of values, such as 0 to 1024 or −500 to +500 for example.

With the aid of a third means M3 a resulting representation EB is generated from a combination of the flash and of the non-flash image GB, UB. For example this combination is performed by weighted addition of the flash and of the non-flash image GB, UB. A non-linear combination can also be used, such as the addition of the squared values of the non-flash image and the values of the flash image. In general the combination is not restricted to the examples given. Thus, through the combination of the flash and of the non-flash image GB, UB, described by the following equation, a brightness value YE of the resulting representation EB can be determined:

Y_{E}(I,j)=a*Y_{UB}(I,j)+b*Y_{GB}(I,j)

In this case (I, j) describes a two-dimensional position of a pixel BP within an image or a representation, YUB a brightness component of the non-flash image UB and YGB a brightness component of the flash image GB. Furthermore the weighting factors a, b indicate the weighting of the brightness value of the respective non-flash or flash image UB, GB. In practice it is sensible that “a+b=1”. In an advantageous embodiment variant “a=b=0.5”.

Both the non-flash image UB and also the flash image GB can in an alternative expansion of the inventive method be generated by overlaying a number of non-flash exposures UOB or flash exposures GOB. This is explained in greater detail with the aid of FIG. 8. In this case for example three non-flash exposures UOB are created by a digital camera. With the aid of a fourth means M4 a modified non-flash exposure UOB′ is generated from these three non-flash exposures UOB. In this case the modified non-flash exposure UOB′ can be calculated by pixel-by-pixel overlaying of the individual non-flash exposures UOB.

To avoid lack of sharpness within the modified non-flash exposure UOB′ a movement compensation BK of the non-flash exposure UOB can be undertaken by the fourth means M4 before overlaying. With the aid of overlaying of a number of exposures such as the non-flash exposures UOB for example a reduction of the image noise can be achieved.

After generation of the modified non-flash exposure UOB′ this is forwarded for brightness and/or color adjustment HA, FA to the first means M1. The further processing steps correspond to the embodiment for the first means M1. The procedure for flash exposure GOB is similar to the processing steps for non-flash exposure UOB.

The mobile radio device MG in accordance with FIG. 1 comprises the image coding device BV. This image coding device BV is able, with the aid of the first, second and third means M1, M2, M3, to execute the inventive image coding method. In addition the image coding device BV can also include the fourth means M4. In an alternative variant the fourth means is integrated into the first and/or second means M1, M2. Furthermore the first and second means M1, M2 can also be integrated into a single means.

For improving the image quality, in a further variant of the inventive image coding method the third means M3 can have a movement compensation BK at its disposal. The result achieved by this movement compensation BK is that movement compensation is undertaken for the first non-flash image UB and the flash image GB before the combination. The result achieved by this is for example that lack of sharpness in the resulting image EB is reduced or avoided.

Finally the quality of the flash and/or non-flash image GB, UB can be processed by at least one image enhancement method BVM, especially through noise reduction. Thus a noise suppression filter can be applied to the flash image GB for reduction of the image noise. Further image enhancement methods, such as for example filters for sharpening the edges within the respective image, can achieve a further improvement of the image quality. The brightening of the non-flash or flash images UB, GB can be employed as further image improvement methods. These image enhancement methods BVM can in each case be present and executed in the means M1 to M4.

### LITERATURE REFERENCES

[1] Stefan Zink, Praxis digitale Bildverarbeitung, SchwarzWeiβ-Techniken (practice of digital image processing, black and white techniques) IPP Wolframs Verlag, 1996

1-9. (canceled)

10. A method of image coding with at least one non-flash exposure and at least one flash exposure of the same subject, comprising:
creating images from exposures, the images including a non-flash image created from at least one non-flash exposure and a flash image created from at least one flash exposure; and
generating a resulting representation by combining the flash image and the non-flash image;
wherein at least one of the images undergoes at least one brightness or color adjustment during said step of creating for increasing a contrast range of the at least one of the images.

11. The method as claimed in claim 10, wherein the at least one brightness or color adjustment includes adjustment of a brightness or color distribution of one of the non-flash exposure or the flash exposure corresponding to the at least one of the images using linear spreading.

12. The method as claimed in claim 10, wherein the at least one brightness or color adjustment includes adjustment of a brightness or color distribution of one of the non-flash exposure or the flash exposure corresponding to the at least one of the images using linear spreading such that the spreading increases as the probability of occurrence of a brightness or color value of the exposure increases.

13. The method as claimed in claim 10, wherein the at least one of the images undergoes color adjustment and brightness adjustment during said step of creating, the color adjustment of a color distribution of at least one image is performed so that a color value of a pixel is spread with a spread factor that is used for the brightness adjustment of the pixel.

14. The method as claimed in claim 10, wherein said step of creating comprises creating the non-flash image by overlaying one or more of non-flash exposures and creating the flash image by overlaying one or more flash exposures.

15. The method as claimed in claim 14, further comprising the step of performing a movement compensation of at least one of the non-flash exposure or flash exposure before the step of overlaying.

16. The method as claimed in claim 10, further comprising the step of processing a quality of the flash image and non-flash image using at least one image enhancement method.

17. The method as claimed in claim 16, wherein the at least one image enhancement method comprises noise reduction.

18. The method as claimed in claim 10, wherein the step of combining the flash and the non-flash images includes adding the flash and the non-flash images using a weighted addition.

19. An image coding device adapted to execute an image coding method using at least one non-flash presentation and at least one flash presentation of the same subject, comprising:
means for creating images from exposures including first means for creating a non-flash image from at least one non-flash exposure and
second means for creating a flash image from at least one flash exposure; and
means for generating a resulting representation from a combination of the flash image and the non-flash image;
wherein said means for creating comprises means for subjecting at least one of the images to at least one brightness or color adjustment for increasing a contrast range of the at least one of the images.
